(19) United States
(12) Patent Application Publication
(10) Pub. No.: US 2011/0037830 A1
(43) Pub. Date: Feb. 17, 2011

(54) PLUG AND PLAY MULTIPLEXER FOR ANY STEREOSCOPIC VIEWING DEVICE

(75) Inventor: Lachlan Pockett, Tampere (FI)

Correspondence Address: Nokia, Inc., 6021 Connection Drive, MS 2-5-520, Irving, TX, 75039, US

(73) Assignee: NOKIA CORPORATION, Espoo (FI)

(21) Appl. No.: 12/989,550

(22) PCT Filed: Apr. 24, 2008
(86) PCT No.: PCT/IB08/51597

§ 371 Date: Oct. 25, 2010

(51) Int. Cl. H04N 13/00

(52) U.S. Cl. 348/43; 348/E13.003

(57) ABSTRACT

The present invention provides a technique for receiving one or more view signals, each containing information about multiple input images; and forming a combined stereoscopic image signal based at least partly on characterizing the sub-pixel configuration to allow for any sub-pixel configuration to be controlled by a couple of parameters that can be changed depending on which display that the combined stereoscopic image signals is to be displayed. The parameters may include some combination of the number of sub-pixels before pattern repetition, the number of views being displayed, the number of sub-pixels used for each view, or the offset per line; the parameters may determine which subpixels are extracted for a particular display; the combined stereoscopic image signal may contain respective subsets of pixels from left and right images from each of the multiple input signals; the method may form part of a dedicated system as a plug and play that may be adapted for use on a wide variety of stereoscopic displays, including a display forming part of user equipment or a mobile phone or terminal.

### BACKGROUND OF THE INVENTION

1. Field of Invention

The present invention relates to a stereoscopic viewing device; and more particularly, the present invention relates to a plug and play multiplexer for any stereoscopic viewing device.

2. Description of Related Art

In the prior art, stereoscopic displays combine multiple input images to one output image for viewing on the display. These images are either time multiplexed (field sequential) or spatially multiplexed (parallax barrier, lenticular displays etc). for the spatially multiplexed images there is a different sub-pixel arrangement where different sub-pixels need to be effectively extracted from the left and right input image. The processes commonly referred to as multiplexing, interlacing, and interleaving.

The problem is how to efficiently combine multiple images to create an image that needs to be displayed on the display. Different displays have a different sub-pixel arrangement, and so one device/program designed for one display will not create appropriate images for other displays. This process happens multiple times for 3D video so it needs to be efficient. Some multi-view systems can be used with a varying number of input view configurations, allowing for stereoscopic content to be displayed, and also multi-view content to be displayed, but the same system requires totally different masks depending on the mode it is running in.

There is a need for a dedicated system that will most efficiently multiplex the input images for any configuration, having this system as plug and play would enable more flexibility in using the multiplexer on a wide variety of displays, and not need to create new masks every time a manufacturer designs a new display.

Currently masking is commonly used for image spatial multiplexing, where each image is put through a mask to extract the relevant sub-pixels, then the two masked images are combined to create the spatially multiplexed image with relevant components from the different input images. This process is however requiring appropriate masks to be made for each different display sub-pixel configuration, and then the system needs to be changed accordingly, bringing less flexibility in changing displays. A system without the need for masks would be more robust and allow more flexibility in plugging in different displays.

Moreover, it is known that auto-stereoscopic displays direct different pictures in different directions, so that at a given head position the left eye sees one image and the right eye sees a different image. This can be done by using a field sequential display, or using a spatially multiplexed image (or referred to as interlaced/interleaved) on a display that directs specific sub pixels to the left and right eye, such as parallax and lenticular displays.

Each autostereoscopic display requires a different pattern of sub pixels taken from each input view in order to operate properly. It is important to be able to change displays and then assign appropriate multiplexing patterns effectively, and to do these processing stages effectively for real-time multiplexing.

There is one known program that is able to combine multiple images for stereoscopic viewing. However this system has limitations, having trouble with non-standard sub-pixel configurations. It also uses a masking method that is inefficient, by masking each input image with the predefined mask, then adding the masked images together, resulting in many more processor operations.

For other known techniques, see WO2008023917, which discloses a technique encoding and decoding of vertical lines of an image using encoding blocks; and U.S. Patent Publication No. 2008031515, which discloses a changing between vertical and horizontal schemes. It does not seem to specify the actual processing in interlacing, just about how to switch between horizontal and vertical arrangements. There are also several patents on lenticular lens designs. In these patents there might be some references to methods of interlacing images.

In view of this, there is a need in the industry for a better way to display stereoscopic images from a display device.

### SUMMARY OF THE INVENTION

The present invention provides a new and unique method, apparatus and technique for receiving one or more view signals, each containing information about multiple input images; and forming a combined stereoscopic image signal based at least partly on characterizing the sub-pixel configuration to allow for any sub-pixel configuration to be controlled by a couple of parameters that can be changed depending on which display that the combined stereoscopic image signal is to be displayed.

According to some embodiments of the present invention, the parameters may include some combination of the number of sub-pixels before pattern repetition, the number of views being displayed, the number of sub-pixels used for each view, the offset per line, or starting view offset as described below, and may be used to determine which subpixels are extracted for a particular display.

According to some embodiments of the present invention, the combined stereoscopic image signal may contain respective subsets of pixels from left and right images from each of the multiple input signals.

According to some embodiments of the present invention, the technique may include forming it part of a dedicated system as a plug and play that may be adapted for use on a wide variety of displays.

According to some embodiments of the present invention, the combined stereoscopic image signal may take the form of a spatially multiplexed image having relevant sub-pixel components from different input images; and/or the parameters may determine the multiplexing pattern of the combined stereoscopic image signal.

According to some embodiments of the present invention, the technique may include providing the combined stereoscopic image signal to the display to be displayed, including a display forming part of user equipment or a mobile phone or terminal, including in an interlaced or other suitable format either now known or later developed in the future.

In effect, characterising the sub-pixel configuration can allow for any sub-pixel configuration to be controlled by the couple of parameters that can be easily changed. These parameters will then in turn change which sub-pixels are extracted, and then allow for changing of different displays.

According to some embodiments of the present invention, the apparatus may take the form of a display device featuring one or more modules configured to receive one or more view signals, each containing information about multiple input images, and to form a combined stereoscopic image signal based at least partly on characterizing the sub-pixel configuration to allow for any sub-pixel configuration to be controlled by a couple of parameters that can be changed depending on which display that the combined stereoscopic image signal is to be displayed.

According to some embodiments of the present invention, the apparatus may also take the form of a chipset featuring one or more such modules configured for providing the aforementioned functionality.

According to some embodiments of the present invention, the apparatus may also take the form of a computer-readable storage medium having computer-executable components encoded with instructions that, when executed by a computer, perform: receiving one or more view signals, each containing information about multiple input images; and forming a combined stereoscopic image signal based at least partly on characterizing the sub-pixel configuration to allow for any sub-pixel configuration to be controlled by a couple of parameters that can be changed depending on which display that the combined stereoscopic image signal is to be displayed.

According to some embodiments, the present invention can provide a plug and play style of system, advantaging the use of any display to be instantly attached and used without the need for any sort of masking system. In operation, according to some embodiments of the present invention, this system may be more efficient with memory calls not doing redundant copies in the masking process, so make a faster device.

According to some embodiments of the present invention, the technique may be implemented in hardware to get a very fast dedicated all purpose multiplexing chip that can be used on any device, hence creating the fastest possible multiplexing system.

According to some embodiments of the present invention, the technique may create a more flexible multiplexing system and allow for dedicated hardware multiplexing system that is plug and play so can operate on any spatially multiplexed display, allowing for greater flexibility in content creation and handling.

According to some embodiments of the present invention, the technique can be much more efficient, by totally doing away with masks and operates directly in low level memory from running a loop with the appropriate parameters copying only the relevant information from each input image while skipping the operations on other non-relevant pixels. This can result in the number of operations being substantially equal to the resolution of the image, as opposed to doing several operations on each input pixel for each view. Hence removing some operations, and makes a more memory efficient method of combining the images. This method is much more optimum, giving rapid interlacing which is very important for high speed 3D video applications.

According to some embodiments of the present invention, the technique may provide a drastic speed advantage, along with added flexibility changing display sub-pixel pattern by modification of the input parameters.

According to some embodiments of the present invention, the technique may more efficiently combine images for presentation on an autostereoscopic device. It can be implemented on a device using software or as a dedicated hardware component.

### BRIEF DESCRIPTION OF THE DRAWING

The drawing includes the following Figures, which are not necessarily drawn to scale:

FIG. 1 shows a block diagram of a display device according to some embodiments of the present invention.

FIG. 2 shows a block diagram of a chipset according to some embodiments of the present invention.

FIG. 3 shows a flowchart of the basic steps of the method according to some embodiments of the present invention.

FIG. 4a shows a partial view of a screen that forms part of a configuration for a 9 view lenticular display.

FIG. 4b shows the partial view in FIG. 4a having lenticular lens that direct each line of sub-pixels to a different viewing angle.

FIG. 4c shows the partial view in FIG. 4a characterized as a 9 view display, 9 sub-pixels before pattern repetition, 5 sub-pixels offset per line and 1 sub-pixels per view according to some embodiments of the present invention.

FIG. 5 shows a partial view of a screen having parallax barriers for a configuration characterized as a 2 view display, 2 sub-pixels before pattern repetition, 0 sub-pixels offset per line and 1 sub-pixels per view according to some embodiments of the present invention.

FIG. 6 shows an example of a prior art pixel mask.

### BEST MODE OF THE INVENTION

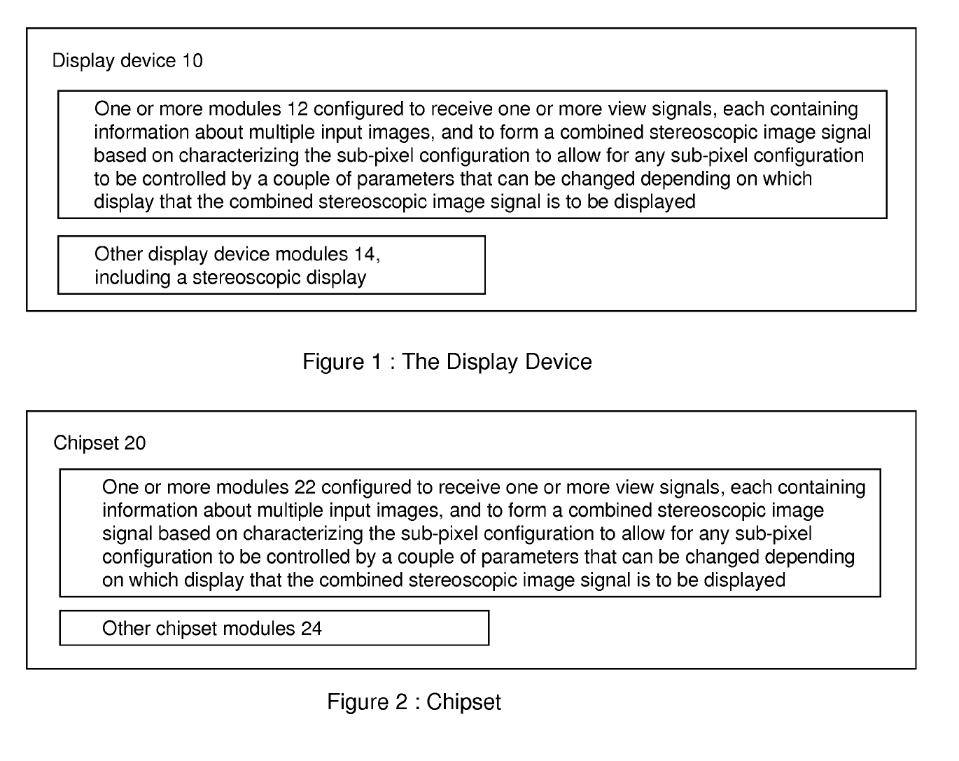

### FIG. 1: The Display Device

FIG. 1 shows a display device 10 according to some embodiments of the present invention. The display device 10 features one or more modules configured to receive one or more view signals, each containing information about multiple input images, and to form a combined stereoscopic image signal based at least partly on characterizing the sub-pixel configuration to allow for any sub-pixel configuration to be controlled by a couple of parameters that can be changed depending on which display that the combined stereoscopic image signal is to be displayed.

According to some embodiments of the present invention, the parameters may include some combination of the number of sub-pixels before pattern repetition, the number of views being displayed, the number of sub-pixels used for each view, the offset per line, or starting view offset as described in more detail below, and may be used to determine which subpixels are extracted for a particular display.

According to some embodiments of the present invention, the combined stereoscopic image signal may contain respective subsets of pixels from left and right images from each of the multiple input signals.

According to some embodiments of the present invention, the one or more modules 12 may be configured to form part of a dedicated system as a plug and play that may be adapted for use on a wide variety of displays.

According to some embodiments of the present invention, the combined stereoscopic image signal may take the form of a spatially multiplexed image having relevant sub-pixel components from different input images; and/or the parameters may determine the multiplexing pattern of the combined stereoscopic image signal.

According to some embodiments of the present invention, the one or more modules 12 may be configured to provide the combined stereoscopic image signal to the display to be displayed, including a display forming part of user equipment or a mobile phone or terminal, including in an interlaced or other suitable format either now known or later developed in the future.

The one or more view signals that are received by the display device 10 may be provided from one or more video devices that are known in the art, that do not form part of the underlying invention, and that are not described in detail herein. The scope of the invention is not intended to be limited to the type or kind of video device providing the one or more view signals, and may include video or other suitable devices either now known or later developed in the future.

The display device 10 also includes other display device modules 14, including a display for displaying stereoscopic images, that do not form part of the underlying invention, and are not described in detail. The scope of the invention is intended to include the type or kind of display device that the present invention may be used in conjunction with; and embodiments may include display devices both now known and later developed in the future. In the case where the display device 10 takes the form of user equipment, a mobile phone or mobile terminal, the other display device modules 14 may include, e.g., numerous electrical or peripheral components or modules such as a camera, a microphone, a keyboard, a radio, a speaker, a touch screen, a display, etc. The numerous electrical or peripheral components or modules are listed by way of example, and the scope of the invention is intended to include other electrical or peripheral components or modules either now known or later developed in the future.

The scope of the invention is also not intended to be limited to performing the aforementioned functionality in one module or two or more modules, or using hardware or software consistent with that described below.

### The Chipset

FIG. 2 shows a basic chipset implementation generally indicated as 20 that forms part of a display device, such as that shown in FIG. 1 according to some embodiments of the present invention, featuring one or more modules configured to receive one or more view signals, each containing information about multiple input images, and to form a combined may include image signal based at least partly on characterizing the sub-pixel configuration to allow for any sub-pixel configuration to be controlled by a couple of parameters that can be changed depending on which display that the combined may include image signal is to be displayed. The term “chipset” is also intended to include the core functionality of a motherboard in such a display device.

### The Basic Method

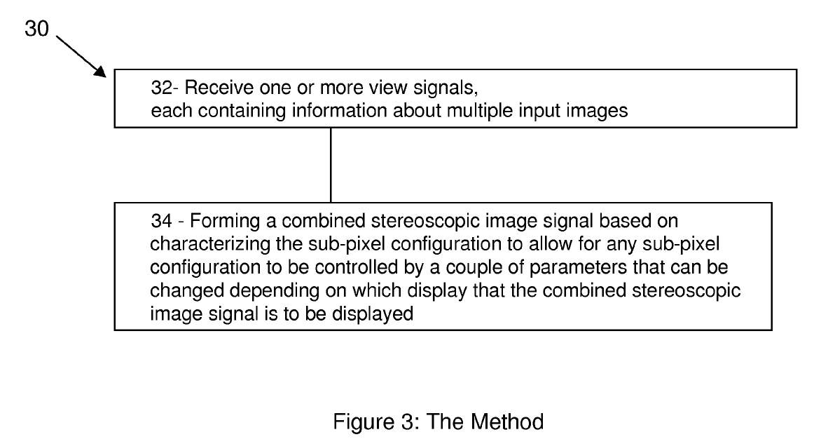

FIG. 3 shows a flowchart 30 having basic steps 32, 34 of the method according to some embodiments of the present invention.

### The Basic Implementations

In particular, the overall technique according to some embodiments of the present invention may be implemented, by way of example, as follows: The special image multiplexing can be characterized by several numbers:
Number of sub-pixels before pattern repetition
Number of views
Number of sub-pixels used for each view
Offset per line
View assignment for top-left pixel

The technique according to some embodiments of the present invention could then be implemented in hardware, or in software.

Here if a software implementation is done, where one sub-routine handles the special multiplexing of any display, and then the parameters in the routine call dictate the multiplexing pattern. In the example below, only 2 input images are used, so the technique features copying the selected sub-pixels from one; however, the technique can also be just as easily implemented with any number of input images (such as the 9 views and the 14 view lenticular display)

This is all tested on several different displays, and produces a properly multiplexed image.

### An Example of a Subroutine

According to some embodiments of the present invention, a subroutine may be used, as follows:

```
static void
interlace_any(GdkPixbuf *outputbuf, GdkPixbuf *inputbuf,
int viewNo, int totalViews,
int lineOffset) {
    int width, height, rowstride, n_channels, X,Y;
    guchar *inPixels, *outPixels;
    n_channels = gdk_pixbuf_get_n_channels (inputbuf);
    g_assert (gdk_pixbuf_get_colorspace (inputbuf) ==
GDK_COLORSPACE_RGB);
    g_assert (gdk_pixbuf_get_bits_per_sample (inputbuf) == 8);
    g_assert (!gdk_pixbuf_get_has_alpha (inputbuf));
    g_assert (n_channels == 3);
    width = gdk_pixbuf_get_width (inputbuf);
    height = gdk_pixbuf_get_height (inputbuf);
    rowstride = gdk_pixbuf_get_rowstride (inputbuf);
    inPixels = gdk_pixbuf_get_pixels (inputbuf);
    outPixels = gdk_pixbuf_get_pixels (outputbuf);
    /*totalpixels=height * rowstride;*/
    for(Y=0; Y<height; Y++){
        for(X=((viewNo+Y*lineOffset)%totalViews);
X<rowstride; X+=totalViews){
            outPixels[X+Y*rowstride]=inPixels[X+Y*rowstride]; } } }
    /*for vertical subpixel*/
    interlacedpixbuf=gdk_pixbuf_copy(finalL);
    interlace_any(interlacedpixbuf,finalR,1,2,0);
    /*for slanted subpixel*/
/*
    interlacedpixbuf=gdk_pixbuf_copy(finalL);
    interlace_any(interlacedpixbuf,finalR,1,2,1);
*/
    /*for moscow operating with 2 input channels*/
/*
    interlacedpixbuf=gdk_pixbuf_copy(finalL);
    interlace_any(interlacedpixbuf,finalR,0,14,1);
    interlace_any(interlacedpixbuf,finalR,1,14,1);
    interlace_any(interlacedpixbuf,finalR,2,14,1);
    interlace_any(interlacedpixbuf,finalR,5,14,1);
    interlace_any(interlacedpixbuf,finalR,6,14,1);
    interlace_any(interlacedpixbuf,finalR,10,14,1);
    interlace_any(interlacedpixbuf,finalR,11,14,1);
*/
    /*for Moscow 14V operating with 14 input channels*/
/*
    interlace_any(interlacedpixbuf,final1,0,14,1);
    interlace_any(interlacedpixbuf,final2,1,14,1);
    interlace_any(interlacedpixbuf,final3,3,14,1);
    interlace_any(interlacedpixbuf,final4,4,14,1);
    interlace_any(interlacedpixbuf,final5,5,14,1);
    interlace_any(interlacedpixbuf,final6,6,14,1);
    interlace_any(interlacedpixbuf,final7,7,14,1);
    interlace_any(interlacedpixbuf,final8,8,14,1);
    interlace_any(interlacedpixbuf,final9,9,14,1);
    interlace_any(interlacedpixbuf,final10,10,14,1);
    interlace_any(interlacedpixbuf,final11,11,14,1);
    interlace_any(interlacedpixbuf,final12,12,14,1);
    interlace_any(interlacedpixbuf,final13,13,14,1);
    interlace_any(interlacedpixbuf,final14,14,14,1);
*/
```

This routine is shown by way of example as one implementation to prove and test the concept. Embodiments are envisioned using other routines to implement the present invention. For instance, as a person skilled in the art would appreciate, this routine set forth above could be optimized for a more efficient application, e.g. using one sweep across the image to copy all appropriate data from the multiple input images. This routine could then take data from any number of input images and just the changing of the parameters dictate which sub-pixels to extract from which input image.

Moreover, the scope of the invention is not intended to be limited to the exact parameter names set forth herein. For instance, a person skilled in the art would appreciate that the parameter name “pixel off set per line” may be referred to as something slightly different, e.g. “angular slant on lenticular lens,” which is effectively the same parameter although technically a different equivalent parameter. In view of this, the scope of the invention is intended to include the parameters set forth above, as well as substantially equivalent parameters to those set forth above either now known or later developed in the future.

### Implementation of the Functionality of Modules 12, 22

By way of example, and consistent with that described herein, the functionality of the modules 12, 22 may be configured and implemented using hardware, software, firmware, or a combination thereof, although the scope of the invention is not intended to be limited to any particular embodiment thereof. In a typical software implementation, the modules 12, 22 would be one or more microprocessor-based architectures having a microprocessor, a random access memory (RAM), a read only memory (ROM), input/output devices and control, data and address buses connecting the same. A person skilled in the art would be able to program such a microprocessor-based implementation to perform the functionality described herein without undue experimentation. The scope of the invention is not intended to be limited to any particular implementation using technology now known or later developed in the future. Moreover, the scope of the invention is intended to include the modules 12, 22 being configured as stand alone modules, as shown, or being configured in the combination with other circuitry for implementing another module.

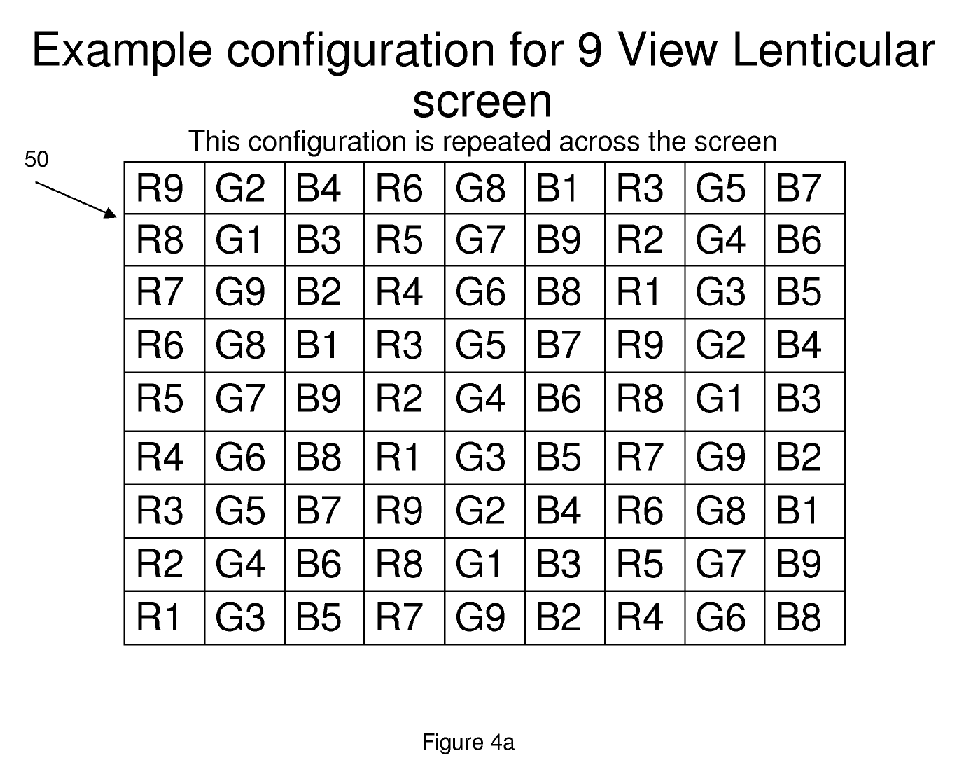

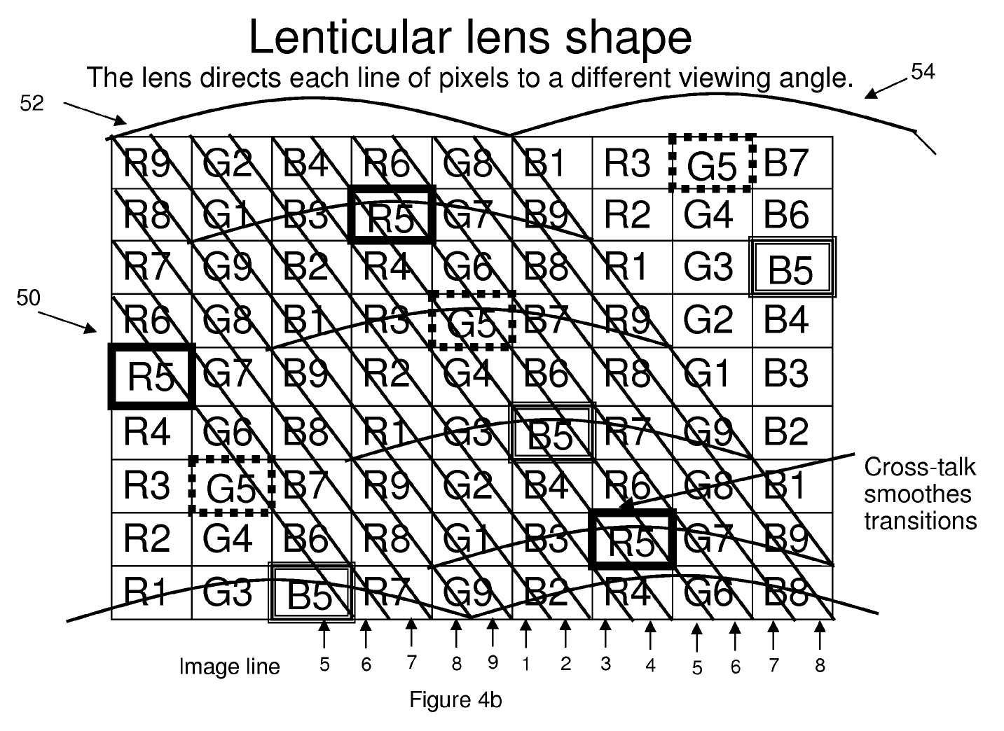

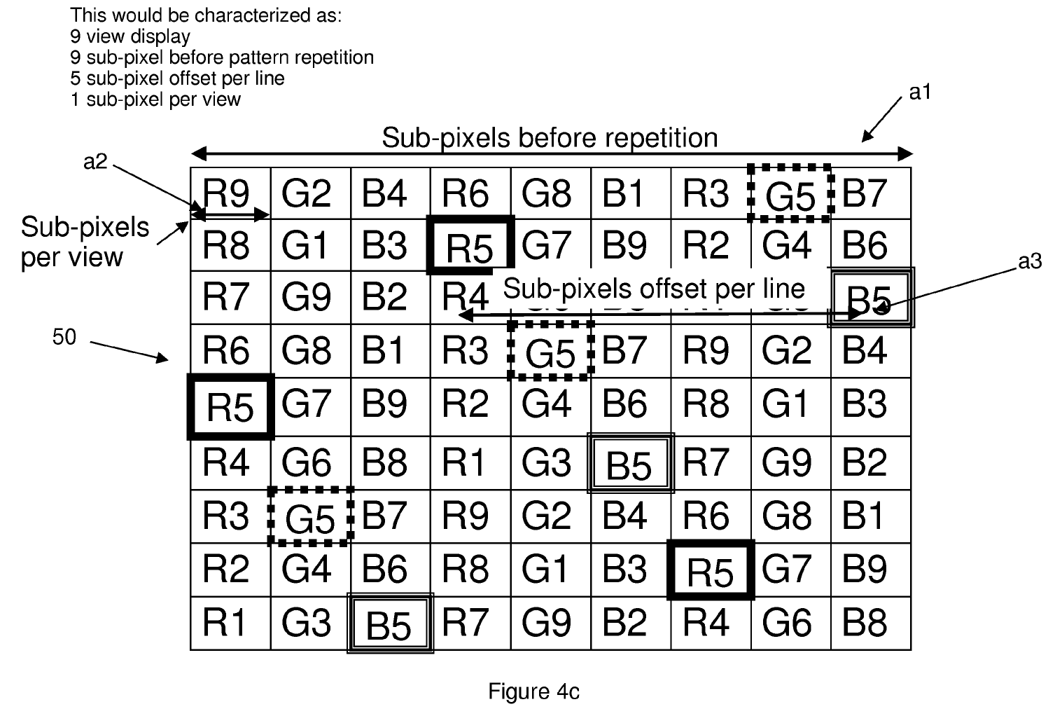

FIGS. 4a-4c: Example of Configuration for a 9 View Lenticular Screen

FIG. 4a shows a partial view of a screen generally indicated as 50 having 9 rows of sub-pixels and 9 columns of sub-pixels that forms part of an example of a configuration for a 9 view lenticular display. As shown, the configuration is repeated across the screen in a red, green and blue pattern, where the 1^{st} column includes a red sub-pixel from each of the 9 views—R1, R2, . . . , R9; the 2^{nd} column includes a green sub-pixel from each of the 9 views—G1, G2, . . . , G9; the 3^{rd} column includes a blue sub-pixel from each of the 9 views—B1, B2, . . . , B9; . . . ; and the 9^{th} column includes a blue sub-pixel from each of the 9 views—B1, B2, . . . , B9. The ordering of the sub-pixels in each column is offset in relation to its adjacent column(s), e.g. the 1^{St} column is arranged as R1, R2, . . . , R9 from bottom to top; the 2^{nd} column is arranged G3, G4, . . . , G9, G1, G2 from bottom to top; . . . ; the 9^{th} column is arranged B8, B9, B1, B2, . . . , B7 from bottom to top. As also show, each row includes alternating red, green and blue sub-pixels from each of the 9 views including 3 red, 3 green and 3 blue sub-pixels from 3 of the 9 views, e.g. the 1 ^{st} row includes R9, G2, B4, R6, G8, B1, R3, G5, B7, and the 2^{nd} row includes R8, G1, B3, R5, G7, B9, R2, G4, B6; . . . ; and the 9^{th} row includes R1, G3, B5, R7, G9, B2, R4, G6, B8.

FIG. 4b shows the partial view of the screen 50 in FIG. 4a having lenticular lens 52, 54 arranged obliquely in relation to the screen 50 that direct each line of sub-pixels to a different viewing angle. Along the bottom of the screen, image lines 5-9 and 1-8 are indicated by arrows. Another arrow also indicates where cross-talk smoothes the transitions. In FIG. 4b, the 9 red, green and blue sub-pixels of the 5^{th} view are shown in shading so as to assist the reader in understanding where this group of sub-pixels is arranged in relation to the lenticular lens 52, 54.

FIG. 4c shows the partial view of the screen 50 in FIG. 4a that is characterized as a 9 view display, 9 sub-pixels before pattern repetition, 5 sub-pixels offset per line and 1 sub-pixels per view according to some embodiments of the present invention. Similar to that shown in FIG. 4b, the 9 red, green and blue sub-pixels of the 5^{th} view are shown in shading so as to assist the reader in understanding where this group of sub-pixels is arranged in relation to the lenticular lens 52, 54. The arrow al along the top of the screen 50 indicates the sub-pixels before repetition; the arrow a2 in the top lefthand corner of the screen 50 indicates the sub-pixels per view; and the arrow a3 in the 3^{rd} row between sub-pixel R4 and B5 of the screen 50 indicates the sub-pixels offset per line.

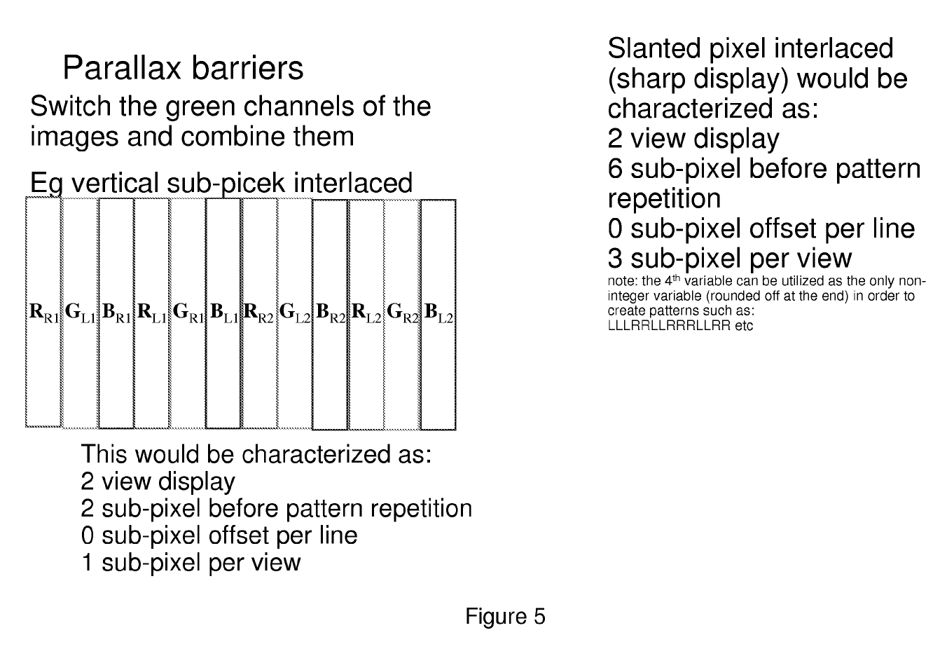

### FIG. 5: Example of Configuration for a 2 View for Screen with Parallax Barriers

FIG. 5 shows a partial view of a screen generally indicated as 60 having parallax barriers for a configuration characterized as a 2 view display, 2 sub-pixels before pattern repetition, 0 sub-pixels offset per line and 1 sub-pixels per view according to some embodiments of the present invention. As shown, the vertical sub-pixels are interlaced in a configuration that is repeated across the screen in a red, green and blue pattern having alternating left and right sub-pixels of the 1^{st} sub-pixel followed by the 2^{nd} sub-pixel, as follows: R_{R1}, G_{L1}, B_{R1}, R_{L1}, G_{R1}, B_{L1}, R_{R2}, G_{L2}, B_{R2}, R_{L2}, G_{R2}, B_{L2}. As show, the row has 12 sub-pixels, including 2 sub-pixels from each of the 2 views for each of the red, green or blue colors.

According to some embodiments of the present invention, a slanted pixel interlace (sharp display) may be characterized as 2 view display, 6 sub-pixels before pattern repetition, 3 sub-pixel offset per line and 3 sub-pixel per view, where the 4th variable can be utilized as the only non-integer variable (rounded off at the end) in order to create patterns such as LLLRRLLRRRLLRR, etc.

### Embodiments Based at Least partly on Non-Integer Based Display Situations

According to some embodiments of the present invention, configuration may be adapted for non-integer based display situations. For example, it is known in the art that, when different arrangements are used such as, e.g., the known 4⅔ display, where the width of the lenticular lens does not perfectly match an integer of the number of sub-pixels, effectively creating a pattern of multiple lenses that repeats over 42 sub-pixels, each of these sub-pixels typically falls at a slightly different point on the lenticular lens, varying also on the row as the lens slants. According to some embodiments of the present invention, this situation can be addressed by setting up, e.g., a 14 view mask configuration, and then assigning the same input image to multiple masks. Multi view images are known to cause a blurring between adjacent pixels as each view fades in and out when changing looking direction, which may cause a blurring effect that can also cause problems with seeing details. According to some embodiments of the present invention, this situation can be addressed by operating a 9 view, or 4⅔ view display in 2 view mode, can give a clearer picture; however, it may not allow for head movement. According to some embodiments of the present invention, it may also be possible to operate in many other arraignments, e.g. 7 view: 1, 1, 2, 2, 3, 3, 4, 4, 5, 5, 6, 6, 7, 7; or on the same display using 4 view configuration 1, 1, 1, (1 or 2 depending on line), 2, 2, 2, 3, 3, 3, (3 or 4 depending on line), 4, 4, 4, or effectively operating with 2 views, L, L, L, L, L, L, L, R, R, R, R, R, R, R, etc. (or many other configurations) thus extending the angular range that one input view is applied to, and causing a shaper transition line between views. The embodiment described herein re configuration for non-integer based display situations are provided by way of example, and the scope of the invention is also intended to include configurations for other types or kind of non-integer based display situations, including non-integer based display situations either now known or later developed in the future.

Moreover, there are many different masks known in the art that may be used for different applications, including ones also having non-standard patterns that may need to be represented by a non-integer pixel per view parameter. According to some embodiments of the present invention, this situation may be handled by appropriately rounding off after multiplication to ensure that the correct input view index is assigned to that sub-pixel.

### Embodiments Having Different Display Parts Operated with Different Input Parameters

Further, according to some embodiments of the present invention, different parts of the display may be operated with different input parameters, e.g. one part of the display may be configured as a 2-view (or just a few views) to give clear text without blurring of views, while another part of the same display may be configured with more than 2-views to allow for smooth motion parallax.

### Embodiments Using a 14-View Mask in a 2-View Configuration

According to some embodiments of the present invention, a 14-view mask may be used in a 2-view configuration by applying one image to the first 7 views and the other image to the other 7 views, creating a 2 view display (less blur than operating in the 14 view mode).

In this case, the pattern may consist of LLLRRLLRRRLLRR, and may be represented by 2⅓ sub-pixels per line. A minor code modification that would be appreciated by a person skilled in the art to the code set forth above would allow it to be used for non-integers configurations. For example, the code may be called multiple times to apply one view to multiple input locations for a 14 view pixel configuration display when using fewer than 14 input views.

This example mask could be represented as:
2 View display
Sub-Pixels before repetition=42
Sub-Pixel offset per line=15

Sub pixels per view=2⅓
Non-integer parameter may be rounded to the nearest integer after multiplication

### Embodiments Using a 5^{th} Parameter

According to some embodiments of the present invention, a 5th parameter may be used in the form of an offset for the starting pixel. This would allow a sub-pixel offset to the starting position of the pattern, e.g. instead of starting with LLLRRLLRRRLLRR it might start with RLLLRRLLRRRLLR. This slightly offsets the view position, thus changing the orientation of the cone of repetition (as one walks around the display one will see view 1-14 sequentially and then jump back to 1). This may be useful for dealing with misalignments in the lenticular lens alignment, as that slight modification can slightly shift the mid-view position. It may also appreciate that if one ever viewed content on one known display known in the art, the lens alignment is always slightly off, so one cannot view the display from a perpendicular position, but has to look at a slight angle. Changing this variable will allow you to instantly modify the input image to view from a perpendicular position. The embodiment using the 5^{th} parameter is described herein by way of example, and the scope of the invention is also intended to include using other types or kind of 5^{th} parameters, including parameters either now known or later developed in the future.

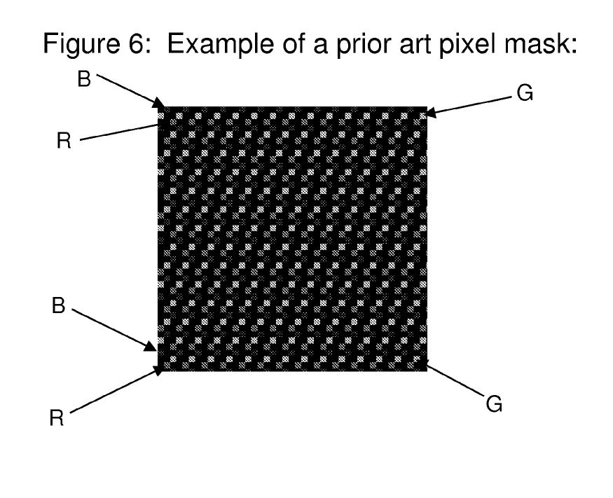

### FIG. 6: The Prior Art Pixel Mask

FIG. 6 shows an example of a prior art pixel mask, having alternating rows of blue, green and red pixels B, G, R (from top to bottom).

### Scope of the Invention

Accordingly, the invention comprises the features of construction, combination of elements, and arrangement of parts which will be exemplified in the construction hereinafter set forth.

It will thus be seen that the objects set forth above, and those made apparent from the preceding description, are efficiently attained and, since certain changes may be made in the above construction without departing from the scope of the invention, it is intended that all matter contained in the above description or shown in the accompanying drawing shall be interpreted as illustrative and not in a limiting sense.

What is claimed is:

1. A method comprising:
receiving one or more view signals, each containing information about multiple input images; and
forming a combined stereoscopic image signal based at least partly on characterizing the sub-pixel configuration to allow for any sub-pixel configuration to be controlled by a couple of parameters that can be changed depending on which display that the combined stereoscopic image signal is to be displayed.

2. A method according to claim 1, wherein the parameters include some combination of the number of sub-pixels before pattern repetition, the number of views being displayed, the number of sub-pixels used for each view, the offset per line, or starting view offset.

3. A method according to claim 1, wherein the parameters determine which subpixels are extracted for a particular stereoscopic display.

4. A method according to claim 1, wherein the combined stereoscopic image signal contains respective subsets of pixels from left and right images from each of the multiple input signals.

5. A method according to claim 1, wherein the method forms part of a dedicated system as a plug and play that may be adapted for use on a wide variety of displays.

6. A method according to claim 1, wherein the combined stereoscopic image signal takes the form of a spatially multiplexed image having relevant sub-pixel components from different input images.

7. A method according to claim 1, wherein the parameters determine the multiplexing pattern of the combined stereoscopic image signal.

8. A method according to claim 1, wherein the method includes providing the combined stereoscopic image signal to the display to be displayed, including a display forming part of user equipment or a mobile phone or terminal.

9. A method according to claim 1, wherein the method comprises providing the combined stereoscopic image signal to the display in an interlaced format.

10. A display device comprising:
one or more modules configured to receive one or more view signals, each containing information about multiple input images, and to form a combined stereoscopic image signal based at least partly on characterizing the sub-pixel configuration to allow for any sub-pixel configuration to be controlled by a couple of parameters that can be changed depending on which display that the combined stereoscopic image signal is to be displayed.

11. A display device according to claim 10, wherein the parameters include some combination of the number of sub-pixels before pattern repetition, the number of views being displayed, the number of sub-pixels used for each view, the offset per line, or starting view offset.

12. A display device according to claim 10, wherein the parameters determine which subpixels are extracted for a particular stereoscopic display.

13. A display device according to claim 10, wherein the combined stereoscopic image signal contains respective subsets of pixels from left and right images from each of the multiple input signals.

14. A display device according to claim 10, wherein the one or more modules form part of a dedicated system as a plug and play that may be adapted for use on a wide variety of displays.

15. A display device according to claim 10, wherein the combined stereoscopic image signal takes the form of a spatially multiplexed image having relevant sub-pixel components from different input images.

16. A display device according to claim 10, wherein the parameters determine the multiplexing pattern of the combined stereoscopic image signal.

17. A display device according to claim 10, wherein the one or more modules are configured to provide the combined stereoscopic image signal to a display in the viewing device, including one forming part of user equipment or a mobile phone or terminal.

18. A display device according to claim 10, wherein the one or more modules are configured to provide the combined stereoscopic image signal to the display in an interlaced format.

19. A chipset comprising:
one or more modules configured to receive one or more view signals, each containing information about multiple input images, and to form a combined stereoscopic image signal based at least partly on characterizing the sub-pixel configuration to allow for any sub-pixel configuration to be controlled by a couple of parameters that can be changed depending on which display that the combined stereoscopic image signal is to be displayed.

20. A chipset according to claim 19, wherein the parameters include some combination of the number of sub-pixels before pattern repetition, the number of views being displayed, the number of sub-pixels used for each view, the offset per line, or starting pixel view offset.

21. A chipset according to claim 19, wherein the parameters determine which subpixels are extracted for a particular display.

22. A chipset according to claim 19, wherein the combined stereoscopic image signal contains respective subsets of pixels from left and right images from each of the multiple input signals.

23. A chipset according to claim 19, wherein the chipset forms part of a dedicated system as a plug and play that may be adapted for use on a wide variety of displays.

24. A chipset according to claim 19, wherein the combined stereoscopic image signal takes the form of a spatially multiplexed image having relevant sub-pixel components from different input images.

25. A chipset according to claim 19, wherein the parameters determine the multiplexing pattern of the combined stereoscopic image signal.

26. A chipset according to claim 19, wherein the one or more modules are configured to provide the combined stereoscopic image signal to the display to be displayed, including a display forming part of user equipment or a mobile phone or terminal.

27. A chipset according to claim 19, wherein the one or more modules are configured to provide the combined stereoscopic image signal to the display in an interlaced format.

28. A computer-readable storage medium having computer-executable components encoded with instructions that, when executed by a computer, perform: receiving one or more view signals, each containing information about multiple input images; and forming a combined stereoscopic image signal based at least partly on characterizing the sub-pixel configuration to allow for any sub-pixel configuration to be controlled by a couple of parameters that can be changed depending on which display that the combined stereoscopic image signal is to be displayed.

29. Apparatus comprising:
means for receiving one or more view signals, each containing information about multiple input images; and
means for forming a combined stereoscopic image signal based at least partly on characterizing the sub-pixel configuration to allow for any sub-pixel configuration to be controlled by a couple of parameters that can be changed depending on which display that the combined stereoscopic image signal is to be displayed.

30. Apparatus according to claim 29, wherein the parameters include some combination of the number of sub-pixels before pattern repetition, the number of views being displayed, the number of sub-pixels used for each view, the offset per line, or starting view offset.

31. A method according to claim 1, wherein different parts of the display may be operated with different input parameters.

32. A display device according to claim 10, wherein the one or more modules are configured to operate different parts of the display with different input parameters.

33. A chipset according to claim 19, wherein the one or more modules are configured to operate different parts of the display with different input parameters.
